(19) United States
(12) Patent Application Publication
(10) Pub. No.: US 2018/0345644 A1
(43) Pub. Date: Dec. 6, 2018

(54) METHOD OF LAMINATING ULTRA-THIN GLASS TO NON-GLASS SUBSTRATES

(71) Applicant: CORNING INCORPORATED, CORNING, NY (US)

(72) Inventors: Kiat Chyai Kang, Painted Post, NY (US); Sue Camille Lewis, Webster, NY (US); Govindarajan Natarajan, Poughkeepsie, NY (US); Marianne Griesbach Park, Oneonta, NY (US); Nathaniel David Wetmore, Corming, NY (US)

(73) Assignee: Corning Incorporated, Corning, NY (US)

(21) Appl. No.: 15/771,694

(22) PCT Filed: Oct. 27, 2016
(86) PCT No.: PCT/US16/58967

§ 371 Date: Apr. 27, 2018

Related U.S. Application Data
(60) Provisional application No. 62/246,806, filed on Oct. 27, 2015.

(51) Int. Cl. B32B 37/14; B32B 17/06; B32B 17/10; B32B 37/00

(52) U.S. Cl. CPC B32B 37/144; B32B 17/061; B32B 17/064; B32B 17/10018; B32B 2037/1253; B32B 17/10761; B32B 17/1077; B32B 17/10788; B32B 37/0015; B32B 17/10743

(57) ABSTRACT

Embodiments of the present disclosure relate generally to methods of forming a laminate structure. In one or more embodiments, the method includes situating an interlayer between a glass substrate and a non-glass substrate having a softening point to form an assembled stack, heating the assembled stack to a temperature in a range of greater than the T_{g} of the interlayer to less than the softening point of the non-glass substrate and applying a force to at least one of the laminate glass surface and the laminate non-glass surface to bond that counter-balances thermal stress and polymer cure forces during bonding and prevents warpage, distortion and breakage of the laminate. In some embodiments, the interlayer has a coefficient of thermal expansion (CTE) at least 10 times greater than the CTE of the glass substrate.

### CROSS-REFERENCE TO RELATED APPLICATIONS

This application claims the benefit of priority under 35 U.S.C. § 119 of U.S. Provisional Application Ser. No. 62/246,806 filed on Oct. 27, 2015 the content of which is relied upon and incorporated herein by reference in its entirety.

### TECHNICAL FIELD

Principles and embodiments of the present disclosure relate generally to methods of forming a laminate structure by bonding an ultra-thin glass substrate to a non-glass substrate with an interlayer at temperatures greater than the T_{g} of the interlayer.

### BACKGROUND

Lamination processes for laminating glass substrates thicker than 300 microns to non-glass substrates have involved roll lamination, UV cure adhesives and glass-to-glass bonding. Roll lamination utilizes a pressure sensitive adhesive to bond at near room temperature. Room temperature adhesives have been used in such processes using glass substrates thicker than 300 microns to form various glass to non-glass laminates.

There is currently a need to provide laminates comprising highly bendable ultra-thin glass substrates (e.g., less than 300 microns thick) bonded to non-glass substrates. Such ultra-thin glass and non-glass laminate structures have commercial value for use in appliances, furniture, decorative panels, architectural accents, cabinet faces, wall covering, marker boards, and as protective outer surfaces on various devices and structures. Glass-substrate laminates provide a varied and enhanced look depending upon the substrate finish, the color of the adhesive, or designs incorporated into the structure. The glass surface facilitates cleaning and easy maintenance of the pristine surface as well as protection of the lower layers of decoration and/or substrate.

A limitation in providing such laminates utilizing ultra-thin glass substrates is that when such products are produced on a large scale utilizing large surface areas and thicker substrates, many manufacturing challenges arise. For example, the CTE of ultra-thin glass is approximately 3 ppm/° C. at temperatures between 0° C. to 300° C., whereas polymer and non-glass substrate CTEs are a couple of orders of magnitude larger than the ultra-thin glass CTE. Additionally, plastic and polymer softening temperatures versus adhesive high temperature bond and cure temperature requirements compete and cause warp, distortion, bubbles and/or breakage in the finished glass-plastic laminates and in ultra-thin glass-metal laminates of certain thicknesses.

It would be desirable to produce laminates including ultra-thin glass that are free from warp, distortion, bubbles and/or breakage when they are processed at high temperatures.

### SUMMARY

Various embodiments are described herein. It will be understood that the embodiments listed below may be combined not only as listed herein, but in other suitable combinations in accordance with the scope of the disclosure.

In one embodiment a method of forming a laminate structure comprises: situating an interlayer comprising a glass transition temperature (T_{g}) and an interlayer coefficient of thermal expansion (CTE) disposed between a glass substrate and a non-glass substrate to form an assembled stack. In one or more embodiments, the glass substrate comprises a glass substrate CTE, a first glass surface and an opposing second glass surface defining a glass substrate thickness. In one or more embodiments, the interlayer CTE is at least 10 times greater, at least 50 times greater or at least 100 times greater than the glass substrate CTE. In one or more embodiments, the non-glass substrate comprises a softening point, a first non-glass surface and a second non-glass surface opposite the first non-glass surface defining a non-glass substrate thickness. The resulting assembled stack has a laminate glass surface and a laminate non-glass surface facing opposite to the laminate glass surface. In one or more embodiments, the method includes heating the assembled stack to a temperature in a range from greater than the T_{g} of the interlayer to less than the softening point of the non-glass substrate, to form the laminate structure having a laminate glass surface and a laminate non-glass surface facing opposite to the laminate glass surface. In one or more embodiments, the method includes applying a force to at least one of the laminate glass surface and the laminate non-glass surface to bond the glass substrate, the non-glass substrate and the interlayer together, wherein the applied force counter-balances thermal stress and polymer cure forces during bonding and prevents warpage, distortion and breakage of the laminate.

In another embodiment, a method of forming a laminate structure comprises: assembling a stack comprising a glass substrate, a non-glass substrate comprising a non-glass substrate softening point, and an interlayer comprising an interlayer Tg disposed between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface; increasing a pressure applied to at least one of the laminate glass surface and a laminate non-glass surface from an initial pressure to an intended pressure to compress the stack; and increasing the temperature of the assembled stack from room temperature to an intended temperature that is greater than the interlayer Tg and less than the non-glass substrate softening point. In one or more embodiments, the pressure applied to at least one of the laminate glass surface and a laminate non-glass surface is at the intended pressure for at least a portion of the time the stack is at the intended temperature.

In one or more embodiments, the glass substrate comprises a first glass surface and a second glass surface opposite the first glass surface defining a glass substrate thickness and the non-glass substrate includes a first non-glass surface and a second non-glass surface opposite the first non-glass surface defining a non-glass substrate thickness.

In another embodiment, a method of forming a laminate structure comprises: assembling a stack comprising a glass substrate having a first glass surface and a second glass surface opposite the first glass surface defining a glass substrate thickness in the range of about 75 μm to about 300 μm between the first surface and the second surface, a non-glass substrate having a first non-glass surface and a second non-glass surface opposite the first non-glass surface defining a non-glass substrate thickness between the first non-glass surface and the second non-glass surface, and a polymer interlayer having a glass transition temperature between at least a portion of the glass substrate and the non-glass substrate, wherein the stack has an outward-facing laminate glass surface and an outward-facing laminate non-glass surface opposite the laminate glass surface; positioning the assembled stack on a first flat surface; positioning a weight having a density and a thickness on top of the stack; and heating the stack to a temperature greater than the glass transition temperature of the polymer interlayer to bond the glass substrate and non-glass substrate together, wherein the weight counter-balances thermal stress and polymer cure forces in the stack during bonding and prevents warpage, distortion and breakage of the laminate.

In another embodiment, a method of forming a warp-free laminate structure with an intended compressive stress comprises: assembling a stack comprising a glass substrate having a glass transition temperature and a first glass surface and a second glass surface opposite the first glass surface defining a glass substrate thickness between the first surface and the second surface, a non-glass substrate having a softening temperature and a first non-glass surface and a second non-glass surface opposite the first non-glass surface defining a non-glass substrate thickness between the first non-glass surface and the second non-glass surface, and an interlayer between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface; increasing a pressure applied to at least one of the laminate glass surface and a laminate non-glass surface from an initial pressure to an intended pressure to compress the stack; increasing temperature of the assembled stack from room temperature to a bond temperature that is greater than the glass transition temperature, and less than the cure temperature of the said interlayer to facilitate bonding and to provide a flat stack and cooling the same; and increasing temperature of the flat stack from room temperature to a temperature that is greater than the bond temperature and less than the softening temperature of the substrate to maximize compressive stress of the laminate structure.

### BRIEF DESCRIPTION OF THE DRAWINGS

Further features of embodiment of the present disclosure, their nature and various advantages will become more apparent upon consideration of the following detailed description, taken in conjunction with the accompanying drawings, which are also illustrative of the best mode contemplated by the applicants, and in which like reference characters refer to like parts throughout, where:

FIG. 1 illustrates an exemplary embodiment of a laminate structure;

FIG. 2 illustrates an exemplary embodiment of assembling a stack;

FIG. 3 illustrates another exemplary embodiment of assembling a stack including a decorative layer;

FIG. 4 illustrates an exemplary embodiment of assembled stack between weighting components;

FIG. 5 illustrates an exemplary embodiment of assembled stack and weighting components in an autoclave, vacuum ovens, vacuum lamination beds and/or high temperature, high pressure devices; and

FIG. 6. illustrates an exemplary embodiment of assembled stack in a vacuum bag.

### DETAILED DESCRIPTION

Before describing several exemplary embodiments, it is to be understood that the disclosure is not limited to the details of construction or process steps set forth herein. Other embodiments are possible and the methods described herein are capable of practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

Principles and embodiments of the present disclosure relate to unique methods that produce laminates that are free from warp, distortion, bubbles and breakage, the laminates comprising an ultra-thin glass substrate and a non-glass substrate. In one or more embodiments, the laminates are manufactured with high temperature adhesives when they are processed at high temperature.

When an ultra-thin glass substrate with a low coefficient of thermal expansion (CTE) is laminated with an interlayer having a much higher CTE to a non-glass substrate with a CTE between that of the thin glass substrate and the interlayer, stresses can be imparted to the laminate structure and warping, bubbles, breakage and/or distortion may occur.

It has been found that unique process profiles with proper control of the heating and/or cooling rate of the laminate structure can reduce or eliminate the formation of bubbles at the interlayer due to outgassing, as well as warpage and breakage caused by differences in the CTE of the glass substrate, the non-glass substrate, and the interlayer that generate stress during heating, including bonding and cure segments, and cooling cycles. Air may be trapped between the laminate layers resulting in air bubbles and delamination in final product or composite laminate.

When the process is controlled to impart a compressive stress due to the differences in the CTEs, the ultra-thin glass substrate takes on characteristics and behaviors of the non-glass substrate. It has surprisingly been found that the ultra-thin glass acquires characteristics, such as impact resistance from the non-glass substrate due to the compressive stress formed in the glass substrate to provide an impact resistant glass. It has also surprisingly been found that the ultra-thin glass can withstand much greater impact force when laminated to stronger non-glass substrates, such as metals and plastics due to compressive force and/or CTE difference between the materials. In such a manner, the properties of the laminate structure can be controlled or engineered by proper selection of the non-glass substrate.

The glass surface facilitates cleaning and easy maintenance of the pristine surface as well as protection of the lower layers of decoration and/or the non-glass substrate.

The present methods relate to processes that bond glass substrates, particularly, ultra-thin glass substrates to non-glass substrates with a high temperature polymer interlayer without forming bubbles, distortion and/or warpage, while providing improved reliability and resilience of the glass substrate.

One or more embodiments relate to a method of forming a laminate structure comprising situating an interlayer between a glass substrate, particularly, an ultra-thin glass substrate and a non-glass substrate to form an assembled stack having a laminate glass surface and a laminate non-glass surface facing opposite to the laminate glass surface.

In the various embodiments, the glass substrate has a first glass surface and a second glass surface opposite the first glass surface defining a glass substrate thickness between the first glass surface and the second glass surface. The first glass surface and second glass surface can be major glass surfaces forming the majority of the glass substrate surface area.

In the various embodiments, the non-glass substrate has a first non-glass surface and a second non-glass surface opposite the first glass surface defining a non-glass substrate thickness between the first non-glass surface and the second non-glass surface. The first non-glass surface and second non-glass surface can be major glass surfaces forming the majority of the non-glass substrate surface area.

The interlayer may be situated between one of the glass surfaces and one of the non-glass surfaces, and bonds to the glass surface and non-glass surface.

In the various embodiments, the method comprises heating the laminate structure to a temperature in a range from greater than the T_{g} of the interlayer to less than the softening point of the non-glass substrate to form the laminate structure having a laminate glass surface and a laminate non-glass surface facing opposite to the laminate glass surface. By heating the laminate structure and the interlayer to a temperature greater than the T_{g} of the interlayer and less than the softening point of the non-glass substrate, the laminate structure can be formed without warping and distortion or with minimal warping of the laminate structure. “T_{g}” or “glass transition temperature” refers to the temperature or temperature region at which the material transitions from a hard, glassy amorphous solid material to a viscous, rubbery liquid material and vice versa.

In the various embodiments, the method comprises applying a force to at least one of the laminate glass surface and the laminate non-glass surface to bond the glass substrate, the non-glass substrate, and the interlayer together. Proper selection of the force, e.g. a weight applied during processing results in a defect free laminate structure. If the weight applied is too great, adhesive may leak out between the glass substrate and the non-glass substrate, resulting in a thin adhesive layer and delamination. If the weight applied is too low, warpage of the laminate structure can occur.

The glass substrate is affixed or bonded to the non-glass substrate and vice versa by the interlayer.

In the various embodiments, the glass substrate is an ultra-thin glass substrate having a glass substrate thickness less than or equal to 300 μm, or in the range of about 1 μm to about 300 μm, or in the range of about 1 μm to about 200 μm, or in the range of about 1 μm to about 100 μm, or in the range of about 10 μm to about 300 μm, or in the range of about 10 μm to about 200 μm, or in the range of about 10 μm to about 100 μm, or in the range of about 75 μm to about 300 μm, or in the range of about 100 μm to about 200 μm. The glass substrate can be chemically strengthened, for example, Gorilla® glass.

In various embodiments, the glass substrate may have a width and length for the major surfaces of up to and including 4 feet by 5 feet or an area up to and including twenty square feet.

In one or more embodiments, the ultra-thin glass substrate has a coefficient of thermal expansion (CTE) in the range of about 3 to about 5 ppm/° C. at temperatures between 0° C. to 300° C.

In the various embodiments, the non-glass substrate has a non-glass substrate thickness in the range of about 10 μm to about 25.4 mm (1 inch), or in the range of about 10 μm to about 12.7 mm (½ inch), or in the range of about 50 μm to about 25.4 mm, or in the range of about 10 μm to about 1 mm. In various embodiments, the non-glass substrate has a non-glass substrate thickness greater than 300 μm.

In various embodiments, the non-glass substrate may be metal, polymeric, plastic, composites, and combinations thereof. In various embodiments, the non-glass substrate may be, for example, stainless steel, aluminum, nickel, brass, bronze, titanium, tungsten, copper, cast iron, noble metal, a polyacrylate, a polycarbonate, a polyethylene, a polypropylene, a polytetrafluoroethylene, a polyimide, a fluoro-polymer, a composite including wood, a composite including a ceramic, and combinations thereof.

In various embodiments, the non-glass substrate may be a metal having a non-glass substrate thickness in the range of about 10 μm to about 12.7 mm, or in the range of about 10 μm to about 5 mm, or in the range of about 10 μm to about 1 mm.

In various embodiments, the non-glass substrate may be a polymer having a non-glass substrate thickness in the range of about 10 μm to about 25.4 mm, or in the range of about 10 μm to about 12.7 mm, or in the range of about 10 μm to about 5 mm.

In the various embodiments, the softening temperature of the non-glass substrate may be equal to or greater than 60° C., for example, for polymers and metals. In the various embodiments, the softening temperature of the non-glass substrate may be in the range of about 50° C. to about 500° C., or in the range of about 100° C. to about 300° C.

In one or more embodiments, the non-glass substrate has a coefficient of thermal expansion (CTE) in the range of about 4.5 to about 200 ppm/° C. at temperatures between 0° C. to 300° C. In various embodiments, the non-glass substrate has a CTE in the range of about 4.5 to about 30 ppm/° C. for a metal substrate, and a CTE in the range of about 50 to about 205 ppm/° C. for a polymer/composite substrate. In one or more embodiments, the CTE of the non-glass substrate is greater than about 10 ppm/° C.

In one or more embodiments, the interlayer may be an adhesive material that bonds the glass substrate to the non-glass substrate during a laminating process, including a polymeric material that bonds at high temperature. In various embodiments, the interlayer may be a polymer selected from the group consisting of standard polyvinyl butyral (PVB), acoustic PVB, ethylene vinyl acetate (EVA), thermoplastic polyurethane (TPU), and an ionomer. In various embodiments, the interlayer may be transparent, the interlayer may be colored or tinted, or designs may be incorporated into the laminate structure at the interlayer.

In the various embodiments, the interlayer has an interlayer thickness in the range of about 10 μm to about 5 mm, or in the range of about 25 μm to about 2.5 mm, or in the range of about 50 μm to about 500 μm. In the various embodiments, the interlayer may have a thickness greater than 250 μm.

In the various embodiments, the T_{g} of the interlayer may be equal to or greater than 30° C. In the various embodiments, the T_{g} of the interlayer may be in the range of about 30° C. to about 212° C., or in the range of about 30° C. to about 130° C., or in the range of about 65° C. to about 100° C. In one or more embodiments, the interlayer has a coefficient of thermal expansion (CTE) in the range of about 100 to about 300 ppm/° C. at temperatures between 0° C. to 300° C.

In various embodiments, the interlayer may have a coefficient of thermal expansion at least one order of magnitude, for example two orders of magnitude (i.e., 100 times) greater than the glass substrate. In various embodiments, the interlayer may have a coefficient of thermal expansion at least 50 times greater than the non-glass substrate, or at least 75 times greater than the non-glass substrate.

In various embodiments, the force applied to at least one of the laminate glass surface and the laminate non-glass surface provides a pressure in the range of about 60 psig to about 115 psig, for example, about 60 psig to about 100 psig, for at least a portion of the time that the laminate structure is at a temperature greater than the T_{g} of the interlayer. In various embodiments, the pressure applied to the laminate glass surface and the laminate non-glass surface may be in the range of about 100 psig to about 150 psig for at least a portion of the time that the laminate structure is at a temperature greater than the T_{g} of the interlayer. In various embodiments, a pressure in the range of about 100 psig to about 150 psig is applied to the laminate structure by an autoclave or such, where the autoclave may also be providing heat to raise the temperature of the laminate structure.

In various embodiments, the laminate structure may be placed within a vacuum bag or vacuum ring. In various embodiments, the force applied to the laminate glass surface and the laminate non-glass surface may be created by evacuating a vacuum bag or vacuum ring. In one or more embodiments, the force is applied by clamping a vacuum ring to the peripheral edge portion of the assembled stack and applying a vacuum to the vacuum ring. The vacuum bag or vacuum ring may be placed in an autoclave.

An aspect of the disclosure relates to a process of forming a laminate structure by placing one or more laminate structures on a surface, and placing one or more object(s) having a weight on one or more of the laminate structures to apply a force to at least the laminate glass surface or the laminate non-glass surface of the laminate structure. In various embodiments, the amount of force applied to a laminate glass surface or the laminate non-glass surface is sufficient to counter-balance thermal stress and polymer cure forces in the assembled stack during said bonding and cure processes and to remove air from between the glass substrate and the non-glass substrate while counter-balancing the stack thermal and polymer cure forces and prevents one or more of warpage, breakage, bubbles and distortion of the laminate. In various embodiments, the force compresses the interlayer to reduce or eliminate gases that would otherwise become trapped between an inward-facing laminate glass surface and an inward-facing laminate non-glass surface.

An aspect of the disclosure also relates to a process of laminating the glass substrate to the non-glass substrate to form the laminate structure. An embodiment of a laminating process comprises assembling a stack comprising a glass substrate, a non-glass substrate, and an interlayer, which may be a polymer adhesive and/or decorative interlayer, where the interlayer is between at least a portion of the glass substrate and the non-glass substrate. The stack can have two outward-facing major surfaces including an outward-facing laminate glass surface and an outward-facing laminate non-glass surface opposite the laminate glass surface. The stack can have two inward-facing major surfaces including an inward-facing laminate glass surface and an inward-facing laminate non-glass surface opposite the laminate glass surface. The interlayer may be positioned between the inward-facing laminate glass surface and the inward-facing laminate non-glass surface.

In one or more embodiments, decorative layers such as decals, vinyl, ink, or paint, may be applied to one or both of the inward-facing laminate glass surface and the inward-facing laminate non-glass surface. In various embodiments, the decorative layer, also referred to as a decoration, may be a decorative vinyl layer applied to the inward-facing laminate glass surface and/or the inward-facing laminate non-glass surface.

In an embodiment of the process, the stack may be positioned on a first flat surface, and a weight having a density and a thickness may be placed on top of the stack. In various embodiments, the first flat surface is formed by a surface of a first glass support, which may be a tray or any other suitable support, where the first flat surface is a horizontal face of a first flat glass tray. In various embodiments, the first glass tray provides a uniform flat surface and rigid support to the stack during processing. In various embodiments, intervening layers may be placed between the stack and the first flat surface, and/or between the stack and the weight, such that the weight does not make direct contact with the outward-facing surface of the stack.

In one or more embodiments, one or more stacks may be arranged on the first glass tray, where each of the one or more stacks has the same height (i.e., thickness). Stacks with unequal thicknesses may result in an unequal application of force to the stack, and layers that do not have complete contact with one another.

In various embodiments, the weight has at least one flat surface that may face an outward-facing surface of the stack. The weight may be an object having at least one flat surface coextensive with the surface on which it is to be placed, for example a glass support or a substrate. Having the weight coextensive with the surface on which it is placed may avoid cantilevered forces being applied to the edges of a glass tray or laminate structure and uneven forces and stresses. The weight may be glass or a non-glass material where the weight has a CTE comparable to the glass tray and glass substrate to reduce or avoid induced stresses during heating and cooling cycles.

In one or more embodiments, the intervening layers between the first flat surface and one of the outward-facing major surfaces of the stack can include a polymer sheet. In one or more embodiments, the intervening layers between the weight and one of the outward-facing major surfaces of the stack can include a polymer sheet and a second support, which may be a glass tray or any other suitable support. The first and/or second glass tray can provide a uniform flat surface and stability during processing. The first and second glass trays may be the same length, width, and thickness. In various embodiments, the first glass tray and/or the second glass tray may be chemically strengthened glass sheets, where the first glass tray and/or the second glass tray may have a thickness in the range of about 0.5 mm to about 1.5 mm.

In various embodiments, the polymer sheet may be polytetrafluoroethylene sheet, a polyimide sheet, a polypropylene sheet, or a polyethylene sheet. In various embodiments, the polymer sheet may have a thickness in the range of about 2 mil to about 15 mil. The polymer sheet may serve as a barrier between the assembled stack and the glass trays to facilitate finished part removal. The polymer sheet may also protect the surfaces of the stack in contact with the polymer sheet(s) from surface scratches and damage, and to prevent texture transfer onto the structure.

In one or more embodiments, the layers of the stack and weighting components are cleaned before stacking onto the previous layer to avoid the presence of dust and dirt that could introduce flaws, stresses, and possibly break the glass substrate.

In one or more embodiments, the amount of weight positioned on a stack is controlled to avoid over-compressing the interlayer and forcing the interlayer out from between the glass substrate and non-glass substrate.

In various embodiments, once a stack has been assembled and the weight has been applied, the stack may be heated from an ambient condition, for example standard ambient temperature and pressure (25° C./77° F., 1 Bar), to a greater temperature greater than the T_{g} of the interlayer. In one or more embodiments, the stack may be heated from room temperature (25° C.) to a temperature in the range of about 30° C. to about 140° C.

In one or more embodiments, the assembled stack and weighting components may be placed within an autoclave that is configured to apply heat and/or pressure to the assembled stack. The process parameters of the autoclave include temperature, pressure, and/or vacuum. In various embodiments, the autoclave may increase the temperature of the stack from standard ambient temperature or room temperature to a temperature greater than standard ambient temperature or room temperature. In various embodiments, the temperature of the stack is increased to a temperature greater than the T_{g} of the interlayer forming the stack. The temperature of the stack may be increased to a temperature less than the softening point of the non-glass substrate if the non-glass substrate has a softening point. In one or more embodiments, the softening point of the non-glass substrate is less than about 250° C. In one or more embodiments, the shear modulus or the modulus of rigidity of the non-glass substrate is less than 30 GPa.

In various embodiments, the temperature of the stack may be increased at a rate in the range of about 0.5° C./min. to about 5.0° C./min, or in the range of about 1.0° C./min. to about 5.0° C./min, or in the range of about 1.0° C./min. to about 2.5° C./min, or in the range of about 1.5° C./min to about 2.5° C./min.

In one or more embodiments, the temperature of the stack may be maintained at a steady intended temperature for a period of time in the range of about 10 minutes to about 60 minutes, or in the range of about 15 minutes to about 50 minutes, or in the range of about 20 minutes to about 45 minutes.

In one or more embodiments, the temperature of the stack may be increased from an initial temperature to a maximum temperature over two or more intervals, where the rate that the temperature increases during each of the two or more intervals may be the same or different. In various embodiments, the temperature of the stack may be reduced between heating cycles to create multiple intervals at different temperatures. A uniform temperature may be maintained through the thickness of the stack and across the major surfaces during one or more intervals to achieve a bubble and delamination free laminate structure.

In one or more embodiments, the force applied to at least one of the laminate glass surface and the laminate non-glass surface is part static weight and part dynamic, and it is increased from an initial value to a maximum value. In various embodiments, the pressure applied to the stack within the autoclave may be increased at a rate in the range of about 1.0 PSI/min to about 15.0 PSI/min, or in the range of about 3.0 PSI/min. to about 10.0 PSI/min, or in the range of about 5.0 PSI/min to about 10.0 PSI/min. In various embodiments, the force may be increased from an initial value to a maximum value, where the force may be maintained at one or more intermediate values.

In various embodiments, the bond cycle and cure cycle may be distinct and discrete when the non-glass substrate is a plastic or polymeric material.

Various exemplary embodiments of the disclosure are described in more detail with reference to the figures. It should be understood that these drawings only illustrate some of the embodiments, and do not represent the full scope of the present disclosure for which reference should be made to the accompanying claims. It also should be noted that the figures are not to scale and the sizes of the various illustrated components are for ease of depiction.

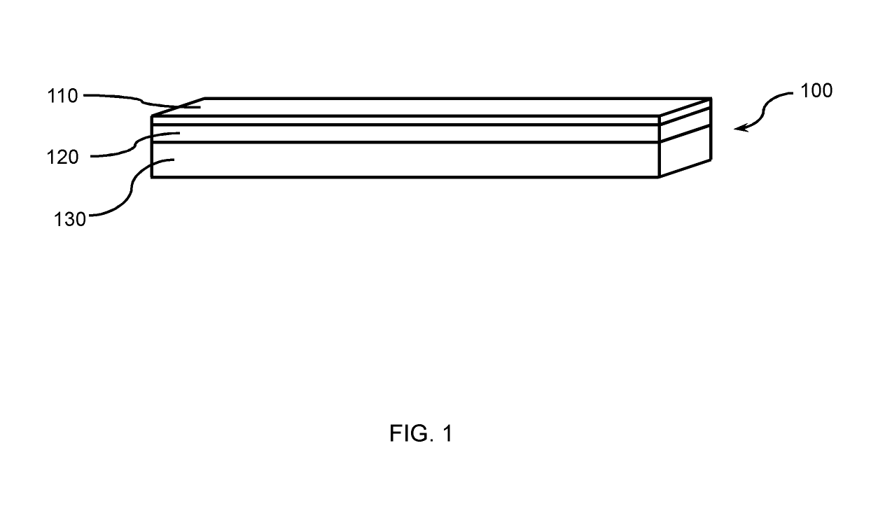

FIG. 1 illustrates an exemplary embodiment of a laminate structure 100. An interlayer 120 is situated between a glass substrate 110 and a non-glass substrate 130, where the interlayer bonds the glass substrate 110 to the non-glass substrate 130. The glass substrate 110 can be an ultra-thin glass substrate with a glass substrate thickness ≤300 μm. The interlayer may have a thickness greater than 100 μm. The non-glass substrate may have a thickness greater than 300 μm.

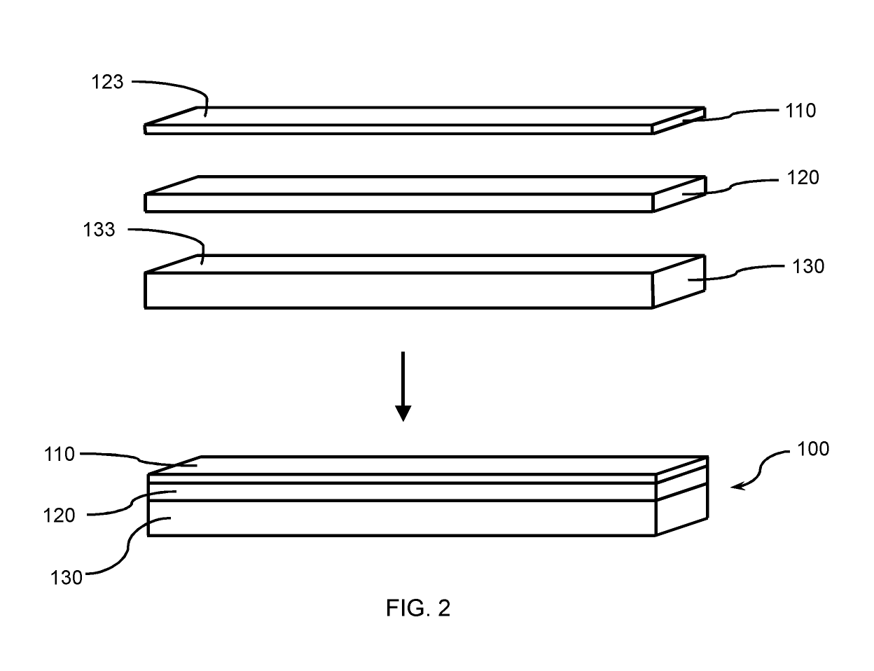

FIG. 2 illustrates an exemplary embodiment of assembling a stack. A non-glass substrate 130 having a first non-glass surface 133 and a second non-glass surface opposite the first non-glass surface defining a non-glass substrate thickness between the first non-glass surface and the second non-glass surface can be placed on a surface. An interlayer 120 is positioned on a first non-glass surface 133, which can be a top surface of the non-glass substrate 130. Positioning a glass substrate 110 having a first glass surface 123 and a second glass surface opposite the first glass surface defining a glass substrate thickness between the first surface and the second surface on the interlayer 120, where the interlayer 120 tacks to the glass surface and non-glass surface, and stack becomes a laminate structure. In other embodiments, the interlayer 120 can be placed on a surface of a glass substrate 110, and the interlayer 120 and glass substrate 110 positioned on the first non-glass substrate surface 133. Pressure can be applied to at least one of the laminate glass surface or laminate non-glass surface, where the pressure can be increased from an initial pressure to an intended pressure to compress the stack. In one or more embodiments, the pressure is increased from an initial pressure to a maximum pressure at a rate of about 3 psig/min to about 15 psig/min. The temperature of the assembled stack can be increased from room temperature to an intended temperature. When there is no gap between layers due to applied pressure and temperature greater than Tg in the assembled stack, the bonding process starts. The bond strength increases in time and attains maximum after cure.

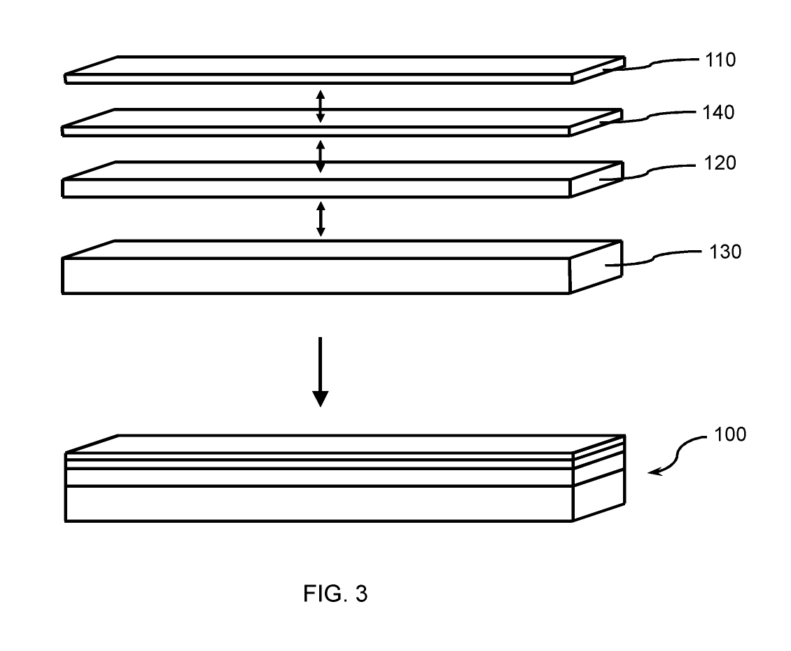

FIG. 3 illustrates another exemplary embodiment of assembling a stack including a decorative layer. An interlayer 120 is applied to the non-glass substrate 130, and a decorative layer 140 is applied to the interlayer 120. A glass substrate 110 is positioned on the decorative layer 140 and interlayer 120 to sandwich the decorative layer between the interlayer 120 and glass substrate 110. In other embodiments, the decorative layer 140 can be applied to the non-glass substrate 130, and the interlayer 120 is applied over the decorative layer 140 and non-glass substrate 130 to sandwich the decorative layer between the interlayer 120 and the non-glass substrate 130. A glass substrate 110 is positioned on the interlayer 120.

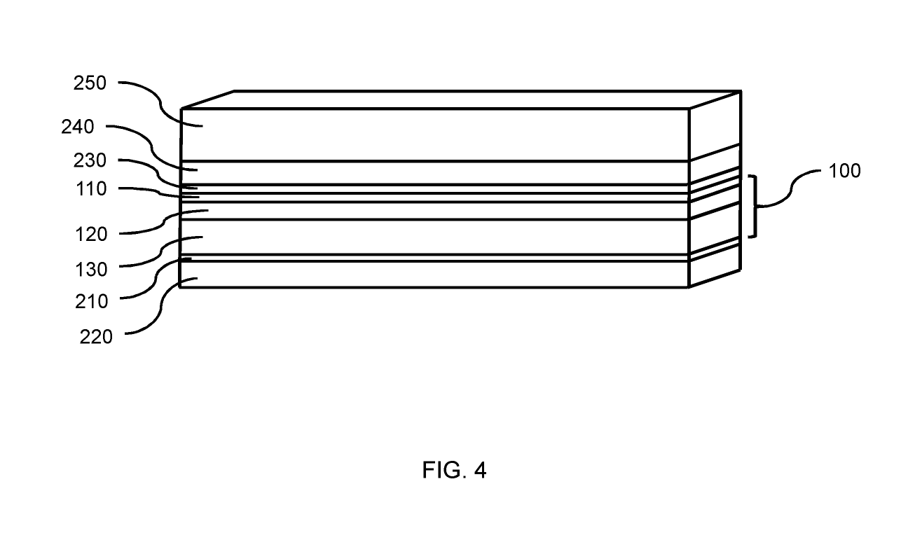

FIG. 4 illustrates an exemplary embodiment of assembled stack between weighting components. A first glass tray 220 can be placed on a flat horizontal surface to support one or more laminate structure(s). A first polymer sheet 210 is positioned on the top surface of the first glass tray 220, where the polymer sheet can be a polytetrafluoroethylene sheet. The non-glass substrate 130 having a non-glass substrate thickness can be placed on the first polymer sheet 210. An interlayer 120 is positioned on the non-glass substrate 130, and a glass substrate 110 is positioned on the interlayer 120. A second polymer sheet 230 is positioned on the exposed horizontal surface of the glass substrate 110, and a second glass tray 240 is positioned on the second polymer sheet 230. A weight 250 is positioned on the exposed horizontal surface of the second glass tray 240 to apply a downward force to the stack and compress the glass substrate 110, the non-glass substrate 130, and the interlayer 120 together. The weight 250 ensures stack flatness by mechanical means, and ensures the stack does not move during the phase change when the temperature of interlayer 120 is increased to a temperature greater than the Tg of the interlayer. Due to the changes in the interlayer's viscous behavior during a lamination cycle, a uniform temperature and pressure across the stack is maintained to achieve a laminate structure that is free from bubbles, distortion, warp and delamination. The weight 250 also counter-balances the assembled stack thermal stress and polymer cure forces, which prevents laminate warpage, distortion and/or breakage.

In other embodiments, a decorative layer may be included between the glass substrate and non-glass substrate.

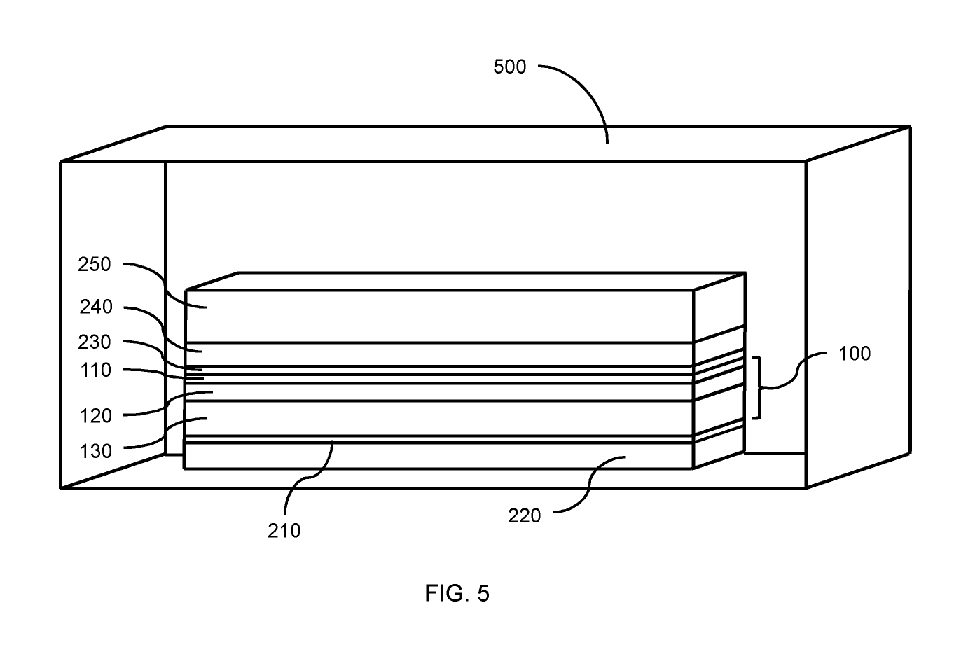

FIG. 5 illustrates an exemplary embodiment of assembled stack and weighting components in an autoclave. The stack and weighting components may be assembled (as described for FIG. 4) within and autoclave 500, or the assembled stack and weighting components may be placed within an autoclave 500, where additional pressure and/or heat can be applied to the stack.

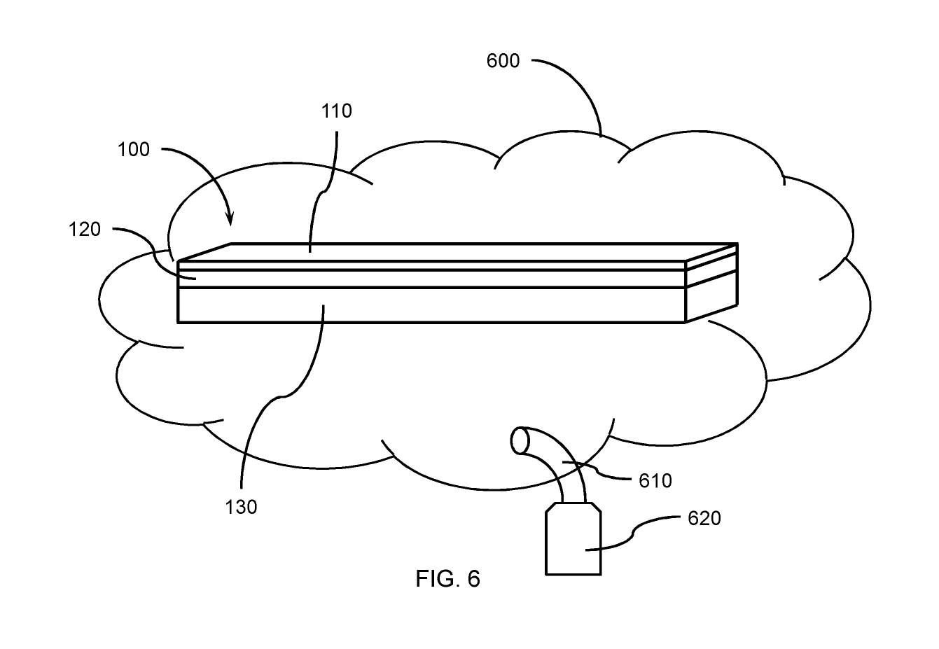

FIG. 6 illustrates an exemplary embodiment of assembled stack in a vacuum bag. A laminate structure 100 can be formed in a vacuum bag 600 by placing a stack within the vacuum bag 600 and evacuating gas from the vacuum bag utilizing a vacuum pump 620 in fluid communication with the vacuum bag 600 through a conduit 610. The vacuum crease a force on the major surfaces of the stack to compress the glass substrate 110, the non-glass substrate 130, and the interlayer 120 together.

The following non-limiting examples shall serve to illustrate the various embodiments of the disclosure.

### Example 1

In a non-limiting example of a method of forming a laminate structure, a first glass tray, which is made of chemically strengthened glass, was positioned in a horizontal orientation to provide a first uniform, flat, rigid surface. The first horizontal glass tray was a bottom glass tray having an exposed top surface. A polymer sheet, which was a polytetrafluoroethylene, was positioned upon at least a portion of the bottom glass tray to provide a barrier between the exposed top surface of the bottom glass tray and a surface of a glass substrate or non-glass substrate. A single polymer sheet covered the entire surface of the bottom glass tray, or a single polymer sheet covered only a portion of the bottom glass sheet upon which laminate structures are to be formed, or a plurality of polymer sheets were arrayed over the exposed top surface of the bottom glass tray to provide positions for placement of a plurality of individual laminate structures. A glass substrate or a non-glass substrate was placed on a polymer sheet. An interlayer comprising an ionomer sheet (e.g., DuPont™ PV5400 SentryGlas® ionomer) was placed on the exposed top surface of the glass substrate or non-glass substrate. A glass substrate or a non-glass substrate was placed on the interlayer to provide a stack, where the stack comprised one glass substrate and one non-glass substrate. A polymer sheet is positioned on top of the stack, and a glass tray is positioned on the polymer sheet. The glass substrate was Willow® Glass, and the glass tray(s) were Gorilla® glass. The polymer sheet prevented the stack from sticking to the glass tray(s). A weight was positioned on the glass tray to apply a compressive force to counter-balance the assembled stack thermal stress and polymer cure forces during said bonding/lamination process, which prevented warpage, distortion and/or breakage of the laminate.

The stack and weighting components were placed in an autoclave, and the temperature of the stack, as measured by a sensor, was increased from room temperature to a maximum intended temperature of 132° C.±1.2° C. at a rate of about 1.67° C./min. over approximately 65 minutes. If the ramp rate was too fast, micro-bubbles were generated due to uneven temperature distribution. After the stack reached the intended temperature of 132° C., the pressure within the autoclave was increased from ambient atmospheric pressure to about 80 psig at a rate of about 5 PSI/min. The glass transition temperature of the adhesive was 65° C. for this example. The formed laminate structure was maintained (i.e., soaked) at the maximum intended temperature and pressure for approximately 30 minutes to bond the laminate structure together. After the laminate structure was soaked at the intended temperature and pressure for the intended time, the temperature was decreased at a rate of about 2.22° C./min. over approximately 15 minutes before the pressure within the autoclave was decreased. The pressure within the autoclave was then decreased from about 80 psig to ambient atmospheric pressure at a rate of about 5 PSI/min. The temperature of the laminate structure reached room temperature before the pressure within the autoclave reached ambient atmospheric pressure. The weight also keeps the trays and stack layers from moving in the autoclave. The counterbalance weight and process profile kept the said laminate warp, distortion and breakage free and maintained the intended compressive stress at the glass layer of the said laminate. Laminates made without these measures were severely warped and distorted and breakage in glass layer of the laminate was observed. Laminates made with thicker non-glass substrates showed more severe damage.

### Example 2

In another non-limiting example of a method of forming a laminate structure, the stack was bonded together during a bond cycle, and then the interlayer was cured during a cure cycle to achieve defect and warpage free laminate structure.

In a bond cycle, a stack was assembled and placed within a vacuum bag or vacuum ring, and the gas (e.g., air, nitrogen, argon, etc.) removed from within the vacuum bag or vacuum ring to create an applied pressure equal to atmospheric pressure on at least the major surfaces of the stack. The temperature of the stack, as measured by a sensor, was increased from room temperature to a maximum intended temperature of 120° C. at a rate of about 2.8° C./min. over approximately 35 minutes, while the vacuum bag or vacuum ring was maintained under a vacuum and a force was applied to the stack. The stack was maintained at a temperature of about 120° C., which is less than the softening temperature of the non-glass structure and a pressure of approximately ambient atmospheric pressure for approximately 30 minutes. After the laminate structure was soaked at the intended temperature and pressure for the intended time, the temperature was decreased at a rate of about 2.32° C./min. over approximately 25 minutes to about 62° C., and then decreased at a rate of about 0.68° C./min. to ambient temperature, before the vacuum within the vacuum bag or vacuum ring was released. Once the glass and non-glass substrates are bonded the laminate acts as a single layer.

In a cure cycle, the bonded laminate structure was assembled and placed within an autoclave. The temperature of the laminate structure, as measured by a sensor, was increased from room temperature to an intermediate intended temperature of 52° C. at a rate of about 1.52° C./min. over approximately 15 minutes. The laminate structure was maintained at the intermediate temperature of 52° C. for approximately 5 minutes, at which point the pressure applied to the laminate structure increased at a rate of about 10 PSI/min. to an intended pressure of 115 PSIG, and maintained the pressure at about 115 PSIG for approximately 110 minutes. The temperature of the laminate structure was increased from the intermediate temperature of 52° C. to a maximum intended temperature of 140° C. at a rate of about 1.52° C./min over approximately 55 minutes, and maintained at 140° C. for approximately 15 minutes. After the laminate structure was soaked at the intended 140° C. temperature and 115 PSIG pressure for the intended time, the temperature is then decreased at a rate of about 3.6° C./min. over approximately 25 minutes to about 50° C., and then decreased at about 0.16° C./min. to room temperature. The pressure was reduced at a rate of 10 PSI/min to ambient atmospheric pressure once the temperature of the laminate structure is less than about 50° C. The interlayer is cured during the cure cycle. The exemplary bond process profile combined with the exemplary cure profile kept the said laminate warp, distortion and breakage free and maintained the intended compressive stress at the glass layer of the said laminate. Without these exemplary unique measures, laminates made without using these process parameters were severely warped and distorted and breakage in glass layer of the laminate was observed. Laminates with thicker non-glass substrates showed more severe damage.

Aspect (1) of this disclosure pertains to a method of forming a laminate structure comprising: situating an interlayer comprising a glass transition temperature (T_{g}) and an interlayer coefficient of thermal expansion (CTE) between a glass substrate and a non-glass substrate to form an assembled stack, wherein the glass substrate comprises a glass substrate CTE, a first glass surface and an opposing second glass surface defining a glass substrate thickness, and wherein the non-glass substrate comprises a softening point, a first non-glass surface and an opposing second non-glass surface defining a non-glass substrate thickness; heating the assembled stack to a temperature in a range of greater than the T_{g} to less than the softening point, wherein the interlayer CTE is at least 10 times greater than the glass substrate CTE to form the laminate structure having a laminate glass surface and an opposing laminate non-glass surface; and applying a force to at least one of the laminate glass surface and the laminate non-glass surface to bond the glass substrate, the non-glass substrate and the interlayer together, wherein the applied force counter-balances thermal stress and polymer cure forces during bonding and prevents warpage, distortion and breakage of the laminate.

Aspect (2) of this disclosure pertains to the method of Aspect (1), wherein the glass substrate thickness is in the range from about 1 μm to about 300 μm, and the interlayer thickness is in the range from about 10 μm to about 5 mm.

Aspect (3) of this disclosure pertains to one or both the methods of Aspect (1) or Aspect (2), wherein the non-glass substrate thickness is in the range from about 10 μm to about 25.4 mm.

Aspect (4) of this disclosure pertains to any one or more of the methods of Aspect (1) through Aspect (3), wherein the non-glass substrate is selected from a material from the group consisting of metal, polymer, plastic, composite, stainless steel, a polyacrylate, a polycarbonate and combinations thereof.

Aspect (5) of this disclosure pertains to any one or more of the methods of Aspect (1) through Aspect (4), wherein the applied force is in the range from about 60 psig to about 100 psig and is applied for at least a portion of the time that the assembled stack is at a temperature greater than the T_{g} of the interlayer.

Aspect (6) of this disclosure pertains to any one or more of the methods of Aspect (1) through Aspect (5), wherein the T_{g} of the interlayer is equal to or greater than 30° C.

Aspect (7) of this disclosure pertains to any one or more of the methods of Aspect (1) through Aspect (6), wherein the applied force is part static weight and part dynamic, and increases from an initial value to a maximum value at a rate in the range from about 3 psig/min to about 15 psig/min.

Aspect (8) of this disclosure pertains to any one or more of the methods of Aspect (1) through Aspect (7), further comprising placing the laminate structure within a vacuum bag or vacuum ring; and evacuating the vacuum bag or vacuum ring to apply the force.

Aspect (9) of this disclosure pertains to the method of Aspect (8), further comprising placing the laminate structure within the vacuum bag or vacuum ring within an autoclave, and increasing the temperature of the laminate structure to an intended temperature for a period of time for the interlayer to cure.

Aspect (10) of this disclosure pertains to any one or more of the methods of Aspect (1) through Aspect (9), further comprising placing one or more laminate structures on a surface, and placing one or more object(s) having a weight on one or more of the laminate structures to apply the force, wherein the applied force is sufficient to counter-balance thermal stress in the assembled stack and polymer cure forces during said bonding and cure processes and remove air from between the glass substrate and the non-glass substrate.

Aspect (11) of this disclosure pertains to a method of forming a laminate structure comprising: assembling a stack comprising a glass substrate having a first glass surface and an opposing second glass surface defining a glass substrate thickness, a non-glass substrate comprising a non-glass substrate softening point and having a first non-glass surface and an opposing second non-glass surface defining a non-glass substrate thickness, and an interlayer comprising an interlayer Tg and disposed between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface; increasing a pressure applied to at least one of the laminate glass surface and a laminate non-glass surface from an initial pressure to an intended pressure to compress the stack; and increasing the temperature of the stack from room temperature to an intended temperature, wherein the pressure applied is at the intended pressure for at least a portion of the time the stack is at the intended temperature, and wherein the intended temperature is greater than the interlayer T_{g} and less than the non-glass substrate softening point to bond the interlayer to the inward-facing laminate glass surface and the inward-facing laminate non-glass surface.

Aspect (12) of this disclosure pertains to one or both the methods of Aspect (11) or Aspect (12), wherein the temperature of the stack is increased from room temperature to the intended temperature at a rate in the range from about 1.0° C./min to about 5.0° C./min and the temperature of the stack is maintained at the intended temperature for a period of time in the range from about 10 minutes to about 60 minutes.

Aspect (13) of this disclosure pertains to any one or more of the methods of Aspect (11) through Aspect (12), wherein the pressure applied to the stack is increased to a maximum intended pressure of up to atmospheric pressure by one or more of placing the stack within a vacuum bag and evacuating gas from the vacuum bag, and positioning a weight on the stack.

Aspect (14) of this disclosure pertains to any one or more of the methods of Aspect (11) through Aspect (13), wherein the pressure applied to the stack is increased from an initial pressure to a maximum pressure at a rate from about 3 psig/min to about 15 psig/min and wherein the temperature of the stack is increased from an initial temperature to a maximum temperature over two or more intervals, where the rate that the temperature increases during each of the two or more intervals may be the same or different.

Aspect (15) of this disclosure pertains to any one or more of the methods of Aspect (11) through Aspect (14), wherein the glass substrate thickness is in the range from about 75 μm to about 300 μm, wherein increasing a pressure applied to at least one of the laminate glass surface and a laminate non-glass surface comprises: positioning the assembled stack on a first surface; and positioning a weight on top of the stack, wherein the weight counter-balances thermal stress and polymer cure forces in the stack during bonding and prevents warpage, distortion and breakage of the laminate.

Aspect (16) of this disclosure pertains to the methods of Aspect (15) wherein the non-glass substrate comprises a metal or plastic, and the interlayer comprises a polymer selected from the group consisting of standard polyvinyl butyral (PVB), acoustic PVB, ethylene vinyl acetate (EVA), thermoplastic polyurethane (TPU), and an ionomer.

Aspect (17) of this disclosure pertains to a method of forming a warp-free laminate structure with an intended compressive stress comprising: assembling a stack comprising a glass substrate comprising a glass transition temperature and comprising a first glass surface and an opposing second glass surface defining a glass substrate thickness, a non-glass substrate comprising a softening temperature and a first non-glass surface and an opposing second non-glass surface defining a non-glass substrate thickness, and an interlayer comprising a cure temperature disposed between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface; increasing a pressure applied to at least one of the laminate glass surface and a laminate non-glass surface from an initial pressure to an intended pressure to compress the stack; increasing temperature of the assembled stack from room temperature to a bond temperature greater than the glass transition temperature, and less than the cure temperature of the said interlayer to facilitate bonding and to provide a flat stack and cooling the same; and increasing temperature of the flat stack from room temperature to a temperature greater than the bond temperature but less than the softening temperature of the substrate to maximize compressive stress of the laminate structure.

Aspect (18) of this disclosure pertains to the methods of Aspect (17), wherein the shear modulus of the non-glass substrate is less than 30 GPa.

Aspect (19) of this disclosure pertains to one or both the methods of Aspect (17) or Aspect (18), wherein the softening point of the non-glass substrate is less than about 250° C. and the non-glass substrate comprises a CTE greater than about 10 ppm/° C.

Aspect (20) of this disclosure pertains to any one or more of the methods of Aspect (17) through Aspect (19), wherein the glass substrate is chemically strengthened.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

1. A method of forming a laminate structure comprising:
situating an interlayer comprising a glass transition temperature (T_{g}) and an interlayer coefficient of thermal expansion (CTE) between a glass substrate and a non-glass substrate to form an assembled stack, wherein the glass substrate comprises a glass substrate CTE, a first glass surface and an opposing second glass surface defining a glass substrate thickness, and wherein the non-glass substrate comprises a softening point, a first non-glass surface and an opposing second non-glass surface defining a non-glass substrate thickness;
heating the assembled stack to a temperature in a range of greater than the T_{g} to less than the softening point, wherein the interlayer CTE is at least 10 times greater than the glass substrate CTE to form the laminate structure having a laminate glass surface and an opposing laminate non-glass surface; and
applying a force to at least one of the laminate glass surface and the laminate non-glass surface to bond the glass substrate, the non-glass substrate and the interlayer together, wherein the applied force counter-balances thermal stress and polymer cure forces during bonding and prevents warpage, distortion and breakage of the laminate.

2. The method of claim 1, wherein the glass substrate thickness is in the range from about 1 μm to about 300 μm, and the interlayer thickness is in the range from about 10 μm to about 5 mm.

3. The method of claim 1, wherein the non-glass substrate thickness is in the range from about 10 μm to about 25.4 mm.

4. The method of claim 1, wherein the non-glass substrate is selected from a material from the group consisting of metal, polymer, plastic, composite, stainless steel, a polyacrylate, a polycarbonate and combinations thereof.

5. The method of claim 1, wherein the applied force is in the range from about 60 psig to about 100 psig and is applied for at least a portion of the time that the assembled stack is at a temperature greater than the T_{g} of the interlayer.

6. The method of claim 5, wherein the T_{g} of the interlayer is equal to or greater than 30° C.

7. The method of claim 1, wherein the applied force is part static weight and part dynamic, and increases from an initial value to a maximum value at a rate in the range from about 3 psig/min to about 15 psig/min.

8. The method of claim 1, further comprising placing the laminate structure within a vacuum bag or vacuum ring; and
evacuating the vacuum bag or vacuum ring to apply the force.

9. The method of claim 8, further comprising placing the laminate structure within the vacuum bag or vacuum ring within an autoclave, and increasing the temperature of the laminate structure to an intended temperature for a period of time for the interlayer to cure.

10. The method of claim 1, further comprising placing one or more laminate structures on a surface, and placing one or more object(s) having a weight on one or more of the laminate structures to apply the force, wherein the applied force is sufficient to counter-balance thermal stress in the assembled stack and polymer cure forces during said bonding and cure processes and remove air from between the glass substrate and the non-glass substrate.

11. A method of forming a laminate structure comprising:
assembling a stack comprising a glass substrate having a first glass surface and an opposing second glass surface defining a glass substrate thickness, a non-glass substrate comprising a non-glass substrate softening point and having a first non-glass surface and an opposing second non-glass surface defining a non-glass substrate thickness, and an interlayer comprising an interlayer Tg and between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface;
increasing a pressure applied to at least one of the laminate glass surface and a laminate non-glass surface from an initial pressure to an intended pressure to compress the stack; and
increasing the temperature of the stack from room temperature to an intended temperature, wherein the pressure applied is at the intended pressure for at least a portion of the time the stack is at the intended temperature, and wherein the intended temperature is greater than the interlayer T_{g} and less than the non-glass substrate softening point to bond the interlayer to the inward-facing laminate glass surface and the inward-facing laminate non-glass surface.

12. The method of claim 11, wherein the temperature of the stack is increased from room temperature to the intended temperature at a rate in the range from about 1.0° C./min to about 5.0° C./min and the temperature of the stack is maintained at the intended temperature for a period of time in the range from about 10 minutes to about 60 minutes.

13. The method of claim 11, wherein the pressure applied to the stack is increased to a maximum intended pressure of up to atmospheric pressure by one or more of placing the stack within a vacuum bag and evacuating gas from the vacuum bag, and positioning a weight on the stack.

14. The method of claim 11, wherein the pressure applied to the stack is increased from an initial pressure to a maximum pressure at a rate from about 3 psig/min to about 15 psig/min and wherein the temperature of the stack is increased from an initial temperature to a maximum temperature over two or more intervals, where the rate that the temperature increases during each of the two or more intervals may be the same or different.

15. The method of claim 11, wherein the glass substrate thickness is in the range from about 75 μm to about 300 μm, wherein increasing a pressure applied to at least one of the laminate glass surface and a laminate non-glass surface comprises:
positioning the assembled stack on a first surface; and
positioning a weight on top of the stack, wherein the weight counter-balances thermal stress and polymer cure forces in the stack during bonding and prevents warpage, distortion and breakage of the laminate.

16. The method of claim 15, wherein the non-glass substrate comprises a metal or plastic, and the interlayer comprises a polymer selected from the group consisting of standard polyvinyl butyral (PVB), acoustic PVB, ethylene vinyl acetate (EVA), thermoplastic polyurethane (TPU), and an ionomer.

17. A method of forming a warp-free laminate structure with an intended compressive stress comprising:
assembling a stack comprising a glass substrate comprising a glass transition temperature and comprising a first glass surface and an opposing second glass surface defining a glass substrate thickness, a non-glass substrate comprising a softening temperature and a first non-glass surface and an opposing second non-glass surface defining a non-glass substrate thickness, and an interlayer comprising a cure temperature disposed between at least a portion of the glass substrate and the non-glass substrate, wherein the stack has an outward-facing laminate glass surface and an outward-facing laminate non-glass surface opposite the laminate glass surface, and an inward-facing laminate glass surface and an inward-facing laminate non-glass surface;
increasing a pressure applied to at least one of the laminate glass surface and a laminate non-glass surface from an initial pressure to an intended pressure to compress the stack;
increasing temperature of the assembled stack from room temperature to a bond temperature greater than the glass transition temperature, and less than the cure temperature of the said interlayer to facilitate bonding and to provide a flat stack and cooling the same; and
increasing temperature of the flat stack from room temperature to a temperature greater than the bond temperature but less than the softening temperature of the substrate to maximize compressive stress of the laminate structure.

18. The method of claim 17, wherein the shear modulus of the non-glass substrate is less than 30 GPa.

19. The method of claim 17, wherein the softening point of the non-glass substrate is less than about 250° C. and the non-glass substrate comprises a CTE greater than about 10 ppm/° C.

20. The method of claim 17, wherein the glass substrate is chemically strengthened.
